(19) United States
(12) Patent Application Publication
(10) Pub. No.: US 2007/0206306 A1
(43) Pub. Date: Sep. 6, 2007

(54) Magnetic head drive circuit

(76) Inventor: Shingo Hokuto, Nishikyo-Ku (JP)

Correspondence Address: CANTOR COLBURN, LLP, 55 GRIFFIN ROAD SOUTH, BLOOMFIELD, CT, 06002, US

(21) Appl. No.: 11/712,647

(22) Filed: Mar. 1, 2007

(30) Foreign Application Priority Data
Mar. 1, 2006 (JP) JP2006-055455
Mar. 1, 2006 (JP) JP2006-055458

(51) Int. Cl. G11B 5/09; G11B 15/12; G11B 5/02

(52) U.S. Cl. 360/46; 360/67; 360/61

(57) ABSTRACT

A recording head drive circuit drives a recording head that records information on a magnetic recording medium. A switching circuit is a H-bridge circuit which includes a plurality of transistors. The switching circuit switches direction of a write current (Iw) flowing in the recording head, in accordance with a conduction state of each transistor. A write current controller controls the write current (Iw) in the recording head. An overshoot control circuit adds an overshoot current (Ios), proportional to the write current (Iw), to the write current (Iw) flowing in the recording head, in a predetermined overshoot time period.

### BACKGROUND OF THE INVENTION

1. Field of the Invention

The present invention relates to a magnetic recording and reproducing apparatus for recording data on, and reproducing data from, magnetic recording media, and in particular, to technology for controlling overshoot electrical current added to write current when recording data.

2. Description of the Related Art

Magnetic recording and reproducing apparatuses represented by hard disks are much used as recording media that are used inside electronic devices of recent years. In such magnetic recording and reproducing apparatuses, a current (referred to below as a write current) flowing in a coil of a write magnetic head (recording head) is controlled in order to record magnetically recorded data. To drive the magnetic head, a magnetic head drive circuit including a switching circuit, such as a H-bridge circuit or the like, is used.

The magnetic head drive circuit controls direction of the write current flowing in the coil of the magnetic head, and also controls amplitude thereof. For example, Patent Document 1 discloses such a magnetic head drive circuit.

As described in Patent Document 1, in the magnetic head drive circuit, when the direction of the write current flowing in the recording head changes, in general the write current is made to overshoot and an attempt to improve the writing performance is made.

Patent Document 1: Japanese Patent Application, Laid Open No. H6-176558

Here, there is a tendency for the writing capability to improve with a larger overshoot amount, but if the overshoot is too large, a side erase problem occurs in which information in neighboring tracks is deleted. Accordingly, with regard to magnetic recording and reproducing apparatuses, control of the write current, that is, control of the overshoot amount, is a very important technology for improving the writing performance.

### SUMMARY OF THE INVENTION

The present invention has been made in light of the these problems, and a general purpose thereof is the provision of a magnetic head drive circuit that can regulate an overshoot amount to a desired value.

An embodiment of the present invention relates to a magnetic head drive circuit for driving a magnetic head that records information on a magnetic recording medium. This magnetic head drive circuit is provided with: a switching circuit which includes a plurality of transistors and which switches direction of a write current flowing in the magnetic head, according to a conduction state of each transistor, a write current controller which controls current value of the write current flowing in the magnetic head, and an overshoot control circuit which adds an overshoot current to the write current flowing in the magnetic head, according to the write current, during a predetermined overshoot time period. The overshoot control circuit may add an overshoot current proportional to the write current.

According to this embodiment, by changing the overshoot current in accordance with the write current, it is possible to accurately control an overshoot amount.

The switching circuit may include: a first high-side switching transistor arranged on a path supplying current to a first terminal of the magnetic head, a first write current control transistor and a first low-side switching transistor arranged in series on a path which draws out current from the first terminal of the magnetic head, a second high-side switching transistor arranged on a path supplying current to a second terminal of the magnetic head, and a second write current control transistor and a second low-side switching transistor arranged in series on a path which draws out current from the second terminal of the magnetic head. The overshoot control circuit may include a first overshoot current control transistor and a first overshoot switching transistor arranged on a path parallel to the path on which the first write current control transistor and the first low-side switching transistor are arranged, and a second overshoot current control transistor and a second overshoot switching transistor arranged on a path parallel to the path on which the second write current control transistor and the second low-side switching transistor are arranged. The switching circuit may switch direction of the write current in accordance with ON-OFF states of the first and second high-side switching transistors and the first and second low-side switching transistors. Control terminals of the first and second write current control transistors and the first and second overshoot current control transistors are commonly connected; the write current controller may control electrical potential of the control terminals that are commonly connected; and the overshoot control circuit may put ON either of the first and second overshoot switching transistors during the predetermined overshoot time period.

According to this configuration, among the various transistors which make up a H-bridge, since respective pairs of transistors: the first write current control transistor and the first low-side switching transistor, the second write current control transistor and the second low-side switching transistor, the first overshoot current control transistor and the first overshoot switching transistor, and the second overshoot current control transistor and the second overshoot switching transistor, have a similar circuit configuration, collector-emitter voltage or drain-source voltage of each transistor is uniform, and it is possible to accurately generate an overshoot current that is proportional to the write current.

The switching circuit may further include a first diode and a first resistor arranged on a path from the first high-side switching transistor to a first terminal of the magnetic head, and a second diode and a second resistor arranged on a path from the second high-side switching transistor to a second terminal of the magnetic head.

By providing the first and second diodes, the electrical potential across the two terminals of the magnetic head can be prevented from rising too much, and it is possible to realize circuit protection. In addition, the magnetic head and the switching circuit are generally connected by wiring formed on a flexible substrate; however, by providing the first and second resistors, impedance desired for the magnetic head can be adjusted by the switching circuit, and it is possible to do impedance matching.

The first and second high-side switching transistors, the first and second write current control transistors, and the first and second overshoot current control transistors may be bipolar transistors, and the first and second low-side switching transistors and the first and second overshoot switching transistors may be field-effect transistors.

A magnetic head drive circuit in another embodiment of the present invention is provided with a switching circuit which includes a plurality of transistors and which switches direction of a write current flowing in a magnetic head, according to a conduction state of each transistor, a write current controller which controls current value of the write current flowing in the magnetic head, an overshoot control circuit which adds an overshoot current, according to the write current, to the write current flowing in the magnetic head during a predetermined overshoot time period, and a clamp circuit which clamps voltage across the two terminals of the magnetic head so that the voltage does not drop below a predetermined clamp voltage.

If the write current is set to be large, the voltage across the two terminals of the magnetic head oscillates to a large extent, due to back electromotive force. The amount of voltage across the two terminals of the magnetic head that oscillates on a ground (or negative supply voltage) side is limited by the clamp circuit. According to this embodiment, by adjusting the clamp voltage, it is possible to set the overshoot voltage to an appropriate value.

The clamp circuit may change the predetermined clamp voltage in accordance with the write current. The clamp circuit may set the predetermined clamp voltage low, as the write current increases.

The clamp circuit includes a bipolar transistor connected to the first terminal of the magnetic head that is a target for clamping by an emitter, and may adjust the clamp voltage by controlling voltage applied to a base of the bipolar transistor.

The abovementioned magnetic head drive circuit may be integrated on one semiconductor substrate. “Integrated” includes cases in which all component elements of the circuit are formed on the semiconductor substrate, and cases in which main component elements of the circuit are integrated, and some resistors, capacitors, or the like, for adjusting a circuit constant may be arranged outside the semiconductor substrate. By integrating the magnetic head drive circuit as one LSI, circuit area can be reduced, and it is possible to maintain uniformity of properties of circuit elements.

A further embodiment of the present invention is a magnetic recording and reproducing apparatus. This apparatus is provided with the abovementioned magnetic head drive circuit. According to this embodiment, since it is possible to appropriately set the overshoot amount of the write current, writing performance can be improved.

Another embodiment of the present invention relates to a magnetic head drive circuit for driving a magnetic head that records information on a magnetic recording medium. This magnetic head drive circuit is provided with: a switching circuit which includes a plurality of transistors and which switches direction of a write current flowing in the magnetic head according to a conduction state of each transistor, a write current controller which controls the write current flowing in the magnetic head, an overshoot control circuit which adds an overshoot current, according to the write current, to the write current flowing in the magnetic head, during a predetermined overshoot time period in which the direction of the write current flowing in the magnetic head changes, and a pull-up circuit which independently pulls up, to a predetermined pull-up level, voltage across the two terminals of the magnetic head, during the overshoot time period.

According to this embodiment, during the overshoot time period, separately from the switching circuit, by making the current path connected to a power supply voltage terminal conductive, and pulling up the voltage across the two terminals of the magnetic head, it is possible to make the write current approach a desired value.

With the two terminals of the magnetic head as a first terminal and a second terminal, and with a direction of flow in which the write current flows in the magnetic head from the first terminal to the second terminal as a first direction, and a direction of flow from the second terminal to the first terminal as a second direction, the pull-up circuit may pull up the voltage of the first terminal when the write current switches from the first direction to the second direction, and may pull up the voltage of the second terminal when the write current switches from the second direction to the first direction.

The pull-up circuit may change the predetermined pull-up level in accordance with the overshoot amount of the write current.

The pull-up circuit includes a first pull-up circuit which includes a first switch and a first resistance component arranged in series on a path from the power supply voltage terminal to the first terminal of the magnetic head and which pulls up the voltage of the first terminal, and a second pull-up circuit which includes a second switch and a second resistance component arranged in series on a path from the power supply voltage terminal to the second terminal of the magnetic head, and either of the first switch or the second switch may be put ON during the overshoot time period.

The resistance component need not necessarily mean a component formed as a resistance element, and may be a transistor or the like, if it has a desired resistance value.

A voltage drop across the first resistance component and the first switch may be set at a value at which, among a plurality of transistors that make up the switching circuit, the transistor arranged on a path supplying current to the first terminal of the magnetic head is not completely OFF, and a voltage drop across the second resistance component and the second switch may be set at a value at which, among a plurality of transistors that make up the switching circuit, a transistor arranged on a path supplying current to the second terminal of the magnetic head is not completely OFF.

Each of the first and second pull-up circuits may include a control transistor functioning as a switch, and plural adjustment transistors connected in parallel to each other, and connected in series to the control transistor. The first and second pull-up circuits may change the pull-up level according to whether any of the plurality of adjustment transistors is ON.

The control transistor and the plurality of adjustment transistors may be field-effect transistors.

The abovementioned magnetic head drive circuit may be integrated on one semiconductor substrate. By integrating the magnetic head drive circuit as one LSI, circuit area can be reduced, and it is possible to maintain uniformity of properties of circuit elements.

A further embodiment of the present invention is a magnetic recording and reproducing apparatus. This apparatus is provided with the abovementioned magnetic head drive circuit. According to this embodiment, since it is possible to appropriately set the overshoot amount of the write current, writing performance can be improved.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing a configuration of a magnetic recording and reproducing apparatus according to a first embodiment;

FIG. 2 is a circuit diagram showing a configuration of a recording head drive circuit according to the first embodiment;

FIG. 3 is an operating waveform diagram of the recording head drive circuit of FIG. 2, when overshoot control is not performed;

FIG. 4 is an operating waveform diagram of the recording head drive circuit of FIG. 2, when overshoot control has been performed;

FIG. 5 is a circuit diagram showing a modified example of a switching circuit of the recording head drive circuit of FIG. 2;

FIG. 6 is a circuit diagram showing part of a configuration of a recording head drive circuit according to a second embodiment;

FIG. 7 is a circuit diagram showing a configuration example of a clamp circuit;

FIG. 8 is an operating waveform diagram of the recording head drive circuit of FIG. 6;

FIG. 9 is a circuit diagram showing a configuration of a recording head drive circuit according to a third embodiment;

FIG. 10 is a circuit diagram showing a configuration example of a pull-up circuit;

FIG. 11 is a circuit diagram showing another configuration example of a first pull-up circuit (or a second pull-up circuit);

FIG. 12 is an operating waveform diagram of the recording head drive circuit of FIG. 9; and

FIG. 13 is a circuit diagram showing a configuration of a recording head drive circuit according to a fourth embodiment.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

### First Embodiment

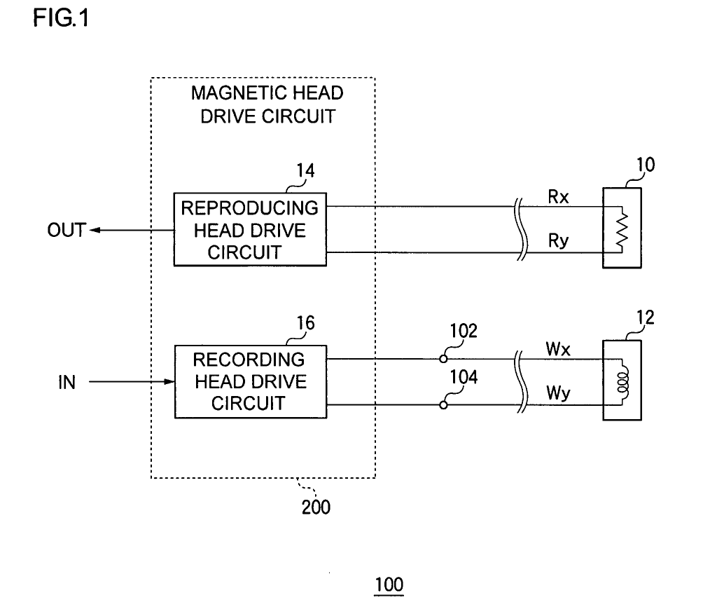

FIG. 1 is a circuit diagram showing a configuration of a magnetic recording and reproducing apparatus 100 according to a first embodiment. This magnetic recording and reproducing apparatus 100 is a hard disk device for writing information to, or reading information from, a magnetic disk not shown in the figure, and includes a reproducing head 10, a recording head 12, and a magnetic head drive circuit 200.

In this magnetic recording and reproducing apparatus 100, a coil is installed in the recording head 12, and is disposed adjacent to the magnetic disk that rotates at a high speed. When a signal current, corresponding to information that is to be recorded, flows, an induction field is generated in the coil of the recording head 12, the magnetic disk is magnetized by a magnetic flux that escapes from a magnetic gap, and the information is written.

The reproducing head 10 includes an MR element in which a resistance value changes according to magnetic flux, and since the resistance value thereof changes depending on the magnetic flux generated from the magnetic disk that is magnetized corresponding to the written information, it is possible to convert the magnetic signal into an electrical signal and perform reading.

The magnetic head drive circuit 200 is a circuit for controlling driving of the magnetic head, that is, the reproducing head 10 and the recording head 12, and a reproducing head drive circuit 14 and a recording head drive circuit 16 are integrated thereon. The magnetic head drive circuit 200 switches in a time-division manner to a read mode when making a reproduction operation, and to a write mode when making a recording operation.

A first terminal 102 and a second terminal 104 of the recording head drive circuit 16 are connected to the recording head 12 via write wiring Wx and Wy. The recording head drive circuit 16 is active when in write mode, and controls an amount and direction of a write current Iw flowing in the recording head 12 corresponding to information written to the magnetic disk.

The reproducing head drive circuit 14 is connected to the reproducing head 10 via read wiring Rx and Ry. The reproducing head drive circuit 14 is active when in read mode, and supplies a constant bias current Ibias to the reproducing head 10. The resistance value of the MR element of the reproducing head changes depending on the magnetic flux of the magnetic disk, and if this resistance value is written as Rmr, voltage drop Vmr across two terminals of the reproduction head 10 is given by Vmr=Rmr×Ibias. Normally, the resistance value of the MR element is a few dozen ohms, and it is possible to obtain a voltage drop of from 0.1 volts to 1 volt, by making a bias current of several milliamps flow. The reproduction head drive circuit 14 extracts, as an electrical signal, information written to the magnetic disk by differential amplification of the voltage drop of the reproduction head 10.

The read wiring Rx and Ry, and the write wiring Wx and Wy are laid in parallel on an FPC (Flexible Printed Circuit) from the magnetic head drive circuit 200 to the reproduction head 10 and the recording head 12. Accordingly, parasitic capacitance, not shown in the figure, exists between each wiring, and wiring resistance also exists.

An embodiment explained below relates to the recording head drive circuit 16 of the magnetic recording and reproducing apparatus 100, and in particular, to technology for improving a writing property.

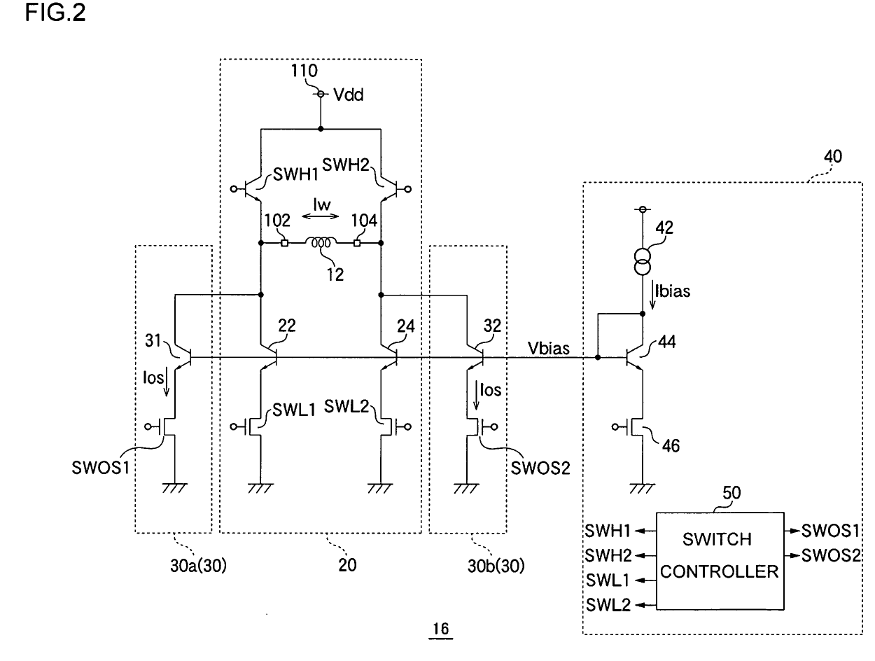

FIG. 2 is a circuit diagram showing a configuration of the recording head drive circuit 16 according to the first embodiment. The recording head drive circuit 16 includes a switching circuit 20, an overshoot control circuit 30, and a write current controller 40, and is integrated as a functional IC on one semiconductor substrate.

The switching circuit 20 includes a plurality of transistors, and switches direction of the current flowing in the recording head 12, in accordance with a conduction state of each transistor. In the present embodiment, the switching circuit 20 is configured as a H-bridge circuit.

In the present embodiment, the switching circuit 20 includes a first high-side switching transistor SWH1, a second high-side switching transistor SWH2, a first write current control transistor 22, a second write current control transistor 24, a first low-side switching transistor SWL1, and a second low-side switching transistor SWL2.

The first high-side switching transistor SWH1 is arranged on a path supplying current from a power supply terminal 110, to which a power supply voltage Vdd is applied, to a first terminal 102 of the recording head 12. Further, the first write current control transistor 22 and the first low-side switching transistor SWL1 are arranged in series on a path which draws out current from a first terminal 102 of the recording head 12.

In the same way, the second high-side switching transistor SWH2 is arranged on a path supplying current from the power supply terminal 110 to the other terminal 104 of the recording head 12. Furthermore, the second write current control transistor 24 and the second low-side switching transistor SWL2 are arranged in series on a path which draws out current from the other terminal of the recording head 12.

In the present embodiment, the first high-side switching transistor SWH1, the second high-side switching transistor SWH2, the first write current control transistor 22, and the second write current control transistor 24 are configured as NPN bipolar transistors. Furthermore, the first low-side switching transistor SWL1 and the second low-side switching transistor SWL2 are configured as N-channel MOSFETs. With regard to these transistors, use of any bipolar transistor or FET is a design issue, and any type, including NPN, PNP, or N-channel, P-channel, may be used as appropriate.

The switching circuit 20 switches direction of the write current Iw according to the first high-side switching transistor SWH1, the second high-side switching transistor SWH2, the first low-side switching transistor SWL1, and the second low-side switching transistor SWL2 being ON or OFF. That is, when the first high-side switching transistor SWH1, and the second low-side switching transistor SWL2 are OFF, the write current Iw flows in the recording head 12 in a direction from the terminal 102 to the terminal 104. Conversely, when the second high-side switching transistor SWH2 and the first low-side switching transistor SWL1 are ON, the write current Iw flows in the recording head 12 in a direction from the terminal 104 to the terminal 102.

The write current controller 40 controls the current value of the write current Iw flowing in the recording head 12. The write current controller 40 includes a constant current source 42, a first transistor 44, a second transistor 46, and a switch controller 50.

The switch controller 50 performs ON and OFF control of switching transistors (in the figure, transistors with reference symbols beginning with SW) configured such that ON-OFF control is possible, and controls the direction of the write current Iw. In addition, in an overshoot time period, the switch controller 50 puts the switching transistors (SWOS1 and SWOS2) ON, and makes active a first overshoot control circuit 30a and a second overshoot control circuit 30b. The switching controller 50 and control terminals (base or gate) of each switching transistor are connected by signal lines not shown in the figures.

The constant current source 42 generates the bias current Ibias proportional to a desired write current Iw. The bias current Ibias is adjusted at appropriate times so that, with ambient temperature and the like as parameters, a preferred write property is obtained. A first transistor 44 and a second transistor 46 are arranged on a path of the bias current Ibias, that is, in series between the constant current source 42 and ground (or negative supply voltage). The first transistor 44 is formed of a transistor of a type similar to the first write current control transistor 22, or the second write current control transistor 24, that is, an NPN bipolar transistor, and the second transistor 46 is formed of a transistor of a type similar to the first low-side switching transistor SWL1 or the second low-side switching transistor SWL2, that is, an N-channel MOSFET.

Bases that are control terminals of the first write current control transistor 22, the second write current control transistor 24, and the first transistor 44 are commonly connected, and form a current mirror circuit. A base voltage Vbias of the first write current control transistor 22 and the second write current control transistor 24 is controlled by the write current controller 40, and a current proportional to the bias current Ibias according to size proportion, flows in the first write current control transistor 22 and the second write current control transistor 24. That is, the first write current control transistor 22 and the second write current control transistor 24 are provided to adjust the current amount of the write current Iw.

The second transistor 46 is put ON during a write operation, by fixing gate voltage thereof.

The overshoot control circuit 30 includes a first overshoot control circuit 30a, and a second overshoot control circuit 30b. The overshoot control circuit 30 adds an overshoot current Ios, in accordance with the write current Iw, to the write current Iw flowing in the recording head 12, during a predetermined overshoot time period. In the present embodiment, the overshoot control circuit 30 adds the overshoot current Ios that is proportional to the write current Iw.

The first overshoot control circuit 30a includes a first overshoot current control transistor 31 and a first overshoot switching transistor SWOS1. The first overshoot current control transistor 31 and the first overshoot switching transistor SWOS1 are arranged in series on a path parallel to a path on which the first write current control transistor 22 and the first low-side switching transistor SWLl are arranged. In the same way, the second overshoot control circuit 30b includes a second overshoot current control transistor 32 and a second overshoot switching transistor SWOS2. The second overshoot current control transistor 32 and the second overshoot switching transistor SWOS2 are arranged in series on a path parallel to a path on which the second write current control transistor 24 and the second low-side switching transistor SWL2 are arranged.

The first overshoot current control transistor 31 and the second overshoot current control transistor 32 are each formed of transistors of a type similar to the first write current control transistor 22, the second write current control transistor 24, or the first transistor 44, that is, an NPN bipolar transistor.

Control terminals of the first overshoot current control transistor 31 and the second overshoot current control transistor 32, that is, bases, are commonly connected with bases of the first write current control transistor 22 and the second write current control transistor 24, and form a current mirror circuit with the first transistor 44. Accordingly, the overshoot current Ios that is proportional to the bias current Ibias, generated by the constant current source 42, flows in the first overshoot current control transistor 31 and the second overshoot current control transistor 32.

The first overshoot switching transistor SWOS1 and the second overshoot switching transistor SWOS2 are formed of transistors of a type similar to the first low-side switching transistor SWL1, the second low-side switching transistor SWL2, and the second transistor 46, that is, an N-channel MOSFET. When the first overshoot switching transistor SWOS1 is ON, the first overshoot control circuit 30a is active, and the overshoot current Ios is added to a write current Iw flowing towards the left in the recording head 12. Conversely, when the second overshoot switching transistor SWOS2 is ON, the second overshoot control circuit 30b is active, and the overshoot current Ios is added to a write current Iw flowing towards the right in the recording head 12. The overshoot control circuit 30 puts either the first overshoot switching transistor SWOS1 or the second overshoot switching transistor SWOS2 ON, in the predetermined overshoot time period.

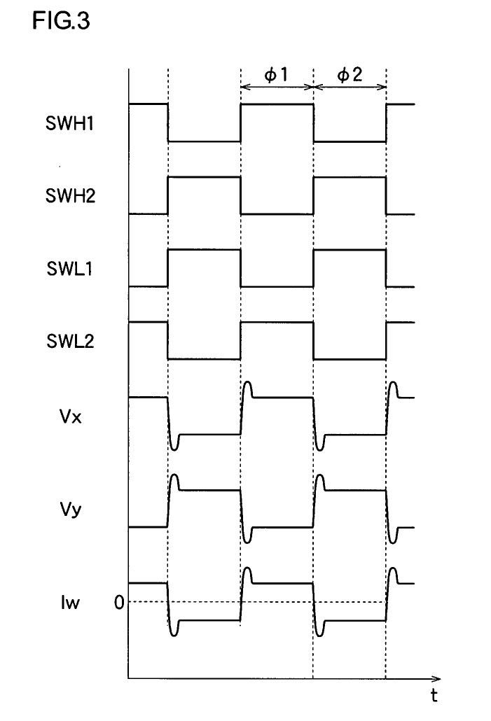

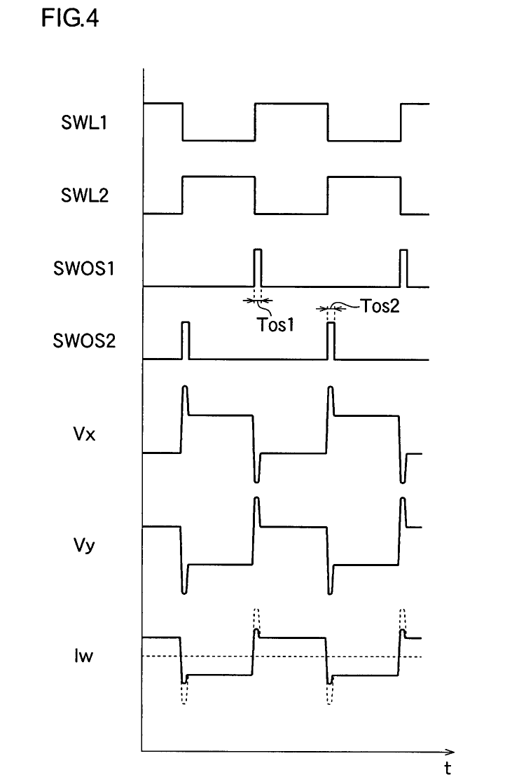

An explanation will be given concerning operation of the recording head drive circuit 16 configured as above. FIG. 3 and FIG. 4 are operating waveform diagrams of the recording head drive circuit 16 of FIG. 2. In FIG. 3, FIG. 4, and later figures, vertical axes and horizontal axes are enlarged or contracted as appropriate in order to facilitate understanding, and each illustrated waveform is shown in simplified form in order to facilitate understanding.

FIG. 3 is an operating waveform diagram when overshoot control is not performed. At this time, both the first overshoot switching transistor SWOS1 and the second overshoot switching transistor SWOS2 are in an OFF state.

In the waveform of the switching transistors (SWH1, SWH2, SWL1, and SWL2), a high level indicates an ON state, and a low level indicates an OFF state. Furthermore, a first voltage Vx indicates voltage of the first terminal 102 of the recording head 12, and the second voltage Vy indicates voltage of the other terminal 104 of the recording head 12. Iw in the lowest tier shows the write current, with a right-directed current as a positive current.

In a time period φ1 the first high-side switching transistor SWH1 and the second low-side switching transistor SWL2 are ON. In this period, the write current Iw is positive, and flows towards the right in the recording head 12. Moreover, in the time period φ1, since the first high-side switching transistor SWH1 is ON, the first voltage Vx is fixed at a potential lower than the supply voltage Vdd, by a drain-source voltage Vds1 of the first high-side switching transistor SWH1 only. On the other hand, since the second low-side switching transistor SWL2 and the second write current control transistor 24 are ON, the second voltage Vy is fixed at a potential close to the sum of drain-source voltage of the second low-side switching transistor SWL2 and the second write current control transistor 24.

In the time period φ2, the second high-side switching transistor SWH2 and the first low-side switching transistor SWL1 are ON, and the write current Iw is negative and flows towards the left in the recording head 12. During this time, the first voltage Vx and the second voltage Vy are opposite to the situation in time period φ1.

When the switching transistors are switched ON or OFF, and the direction of the write current Iw changes, since a back electromotive force is generated in the coil of the recording head 12, the voltage Vx or the voltage Vy overshoot, and the write current Iw increases just a little.

In the recording head drive circuit 16 according to the present embodiment, the transistors (22 and 24) for controlling the current value, and the transistors (SWH1, SWH2, SWL1, and SWL2) for controlling the direction of the current are arranged separately on the H-bridge circuit of the switching circuit 20. As a result, the H-bridge circuit is formed of only four transistors, and in comparison to cases in which switching and current control is performed, it is possible to control the write current with good accuracy.

FIG. 4 is an operating waveform diagram for an overshoot in which the write current Iw is forcibly increased, when the direction of the write current Iw flowing in the recording head 12 is reversed. In FIG. 3, for simplification, the waveform of the high-side switching transistor is omitted.

When the write current Iw is reversed from the left direction to the right direction, the first overshoot switching transistor SWOS1 is ON during a predetermined overshoot time period Tos1. Since the first overshoot switching transistor SWOS1 and the first low-side switching transistor SWL1 are arranged in parallel, by the two transistors being ON at the same time, the write current Iw becomes a current in which the overshoot current Ios, set by the first overshoot current control transistor 31, is added to a normal current set by the first write current control transistor 22. As a result, the write current Iw during the overshoot time period can be made to swing to a large extent as shown by the broken line in FIG. 4.

Furthermore, in the same way for the second overshoot switching transistor SWOS2, when the write current Iw is reversed from being right-directed to being left-directed, the second overshoot switching transistor SWOS2 is ON during a predetermined overshoot time period Tos2, and the write current Iw can be made to overshoot.

Here, as described above, the current value of the overshoot current Ios is controlled by the first overshoot current control transistor 31 and the second overshoot current control transistor 32. These transistors are connected with the first transistor 44 to form a current mirror, and a current proportional to the bias current Ibias occurs. That is, according to the magnetic recording and reproducing apparatus 100 according to the present embodiment, it is possible to control the overshoot current Ios corresponding to the amount of the write current Iw.

In addition, in the present embodiment, each pair of: the first write current control transistor 22 and the first low-side switching transistor SWL1, the second write current control transistor 24 and the second low-side switching transistor SWL2, the first overshoot current control transistor 31 and the first overshoot switching transistor SWOS1, and the second overshoot current control transistor 32 and the second overshoot switching transistor SWOS2 have a similar circuit configuration. As a result, the collector-emitter voltage or the drain-source voltage of every transistor becomes uniform, and it is possible to accurately generate the overshoot current Ios that is proportional to the write current Iw.

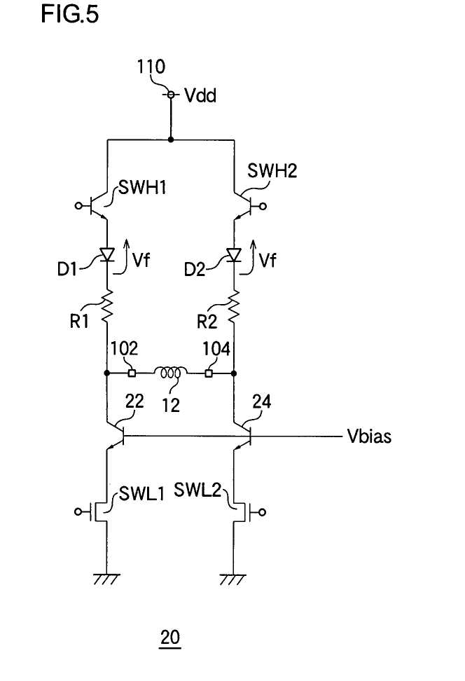

FIG. 5 is a circuit diagram showing a modified example of the switching circuit 20 of the recording head drive circuit 16 of FIG. 2. In the figures below, component elements that are the same as or equivalent to previously described component elements are given the same reference symbols, and explanations are omitted as appropriate.

The switching circuit 20 of FIG. 5 includes a first resistor R1 and a first diode D1 arranged in series on a path from an emitter of the first high-side switching transistor SWH1 to one terminal 102 of the recording head 12. In addition, a second resistor R2 and a second diode D2 are included, arranged in series on a path from an emitter of the second high-side switching transistor SWH2 to the other terminal 104 of the recording head 12.

According to the modified example of FIG. 5, in addition to an effect obtained from the recording head drive circuit 16 of FIG. 2, the effects as below can be obtained.

First, by providing the first diode D1 and the second diode D2, electrical potential of each of the two terminals 102 and 104 of the recording head 12 has a voltage lower, by a diode direction voltage Vf only, than emitter voltage of the first high-side switching transistor SWH1 and the second high-side switching transistor SWH2. As a result, the voltage across the two terminals of the recording head 12 can be prevented from unnecessarily increasing too much, and it is possible to realize circuit protection.

Furthermore, by providing the first resistor R1 and the second resistor R2, it is possible to realize impedance matching. That is, as described above, the recording head 12 is connected to the terminal 102 and the terminal 104, via wiring on a flexible substrate. Parasitic capacitance and wiring resistance are present in this wiring, but cases are also envisaged in which the length of the flexible substrate is different according to each set. Consequently, by providing the first resistor R1 and the second resistor R2, and adjusting the resistance value thereof, mismatching of the impedance can be improved, signal reflectance can be reduced, and it is possible to improve writing performance.

### Second Embodiment

In general, since the overshoot time period Tos is normally extremely short, being a few hundred ps, the current flowing in each of the transistors 22, 24, 31, 32, and 44 deviates from a current value determined by a mirror ratio of the current mirror circuit. As a result, under a certain condition, cases are envisaged in which the overshoot amount of the write current Iw cannot be adequately controlled in the circuit according to the first embodiment. The second embodiment explained below is combined with technology explained in the first embodiment, or is used alone, and relates to technology for accurately controlling overshooting of the write current Iw.

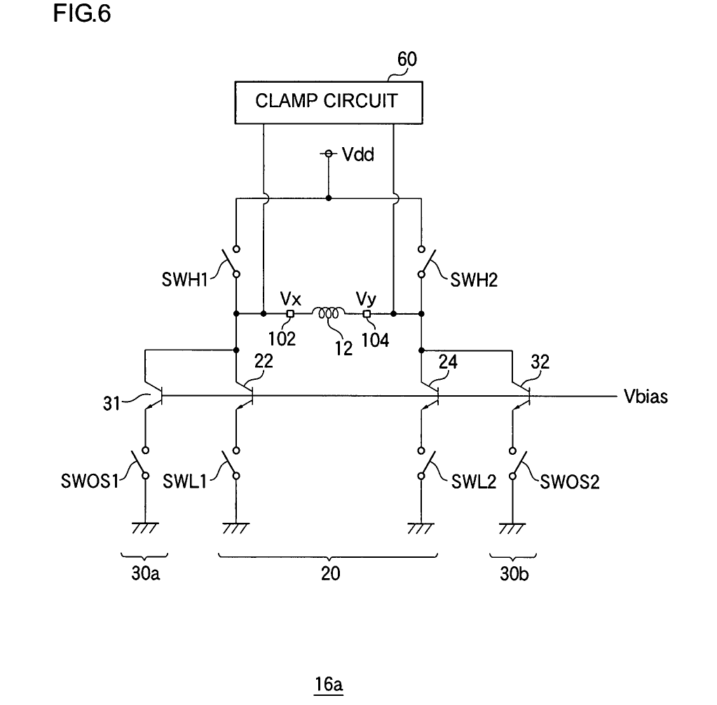

FIG. 6 is a circuit diagram showing part of a configuration of the recording head drive circuit 16a according to the second embodiment. The recording head drive circuit 16a according to the second embodiment is distinguished in that a clamp circuit 60 is provided.

The clamp circuit 60 performs clamping such that the voltage of the two terminals 102 and 104 of the recording head 12, that is, the first voltage Vx and the second voltage Vy, does not drop below a predetermined clamp voltage VCL.

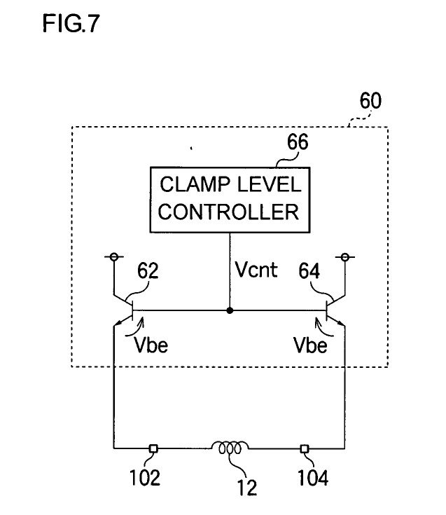

FIG. 7 is a circuit diagram showing a configuration example of the clamp circuit 60. The clamp circuit 60 includes a first clamp transistor 62, a second clamp transistor 64, and a clamp level controller 66. The first clamp transistor 62 and the second clamp transistor 64 are both NPN bipolar transistors, and a control voltage Vcnt generated by a clamp level controller 66 is applied to bases.

The clamp voltage VCL set by the clamp circuit 60 of FIG. 7 is given by VCL=Vcnt−Vbe. Here, Vbe is a base-emitter voltage of the first clamp transistor 62 and the second clamp transistor 64, and is typically approximately 0.7 volts.

The voltages Vx and Vy of the two terminals of the recording head 12 are clamped by the clamp circuit 60 of FIG. 7 so as not to go below the clamp voltage VCL. Furthermore, it is desirable that the clamp circuit 60 changes the clamp voltage VCL according to the write current Iw. More preferably, it is desirable that the clamp circuit 60 sets the clamp voltage VCL low, as the write current Iw increases. As a result, the clamp level controller 66 operates in conjunction with the write current controller 40, and changes the control voltage Vcnt in accordance with the bias current Ibias.

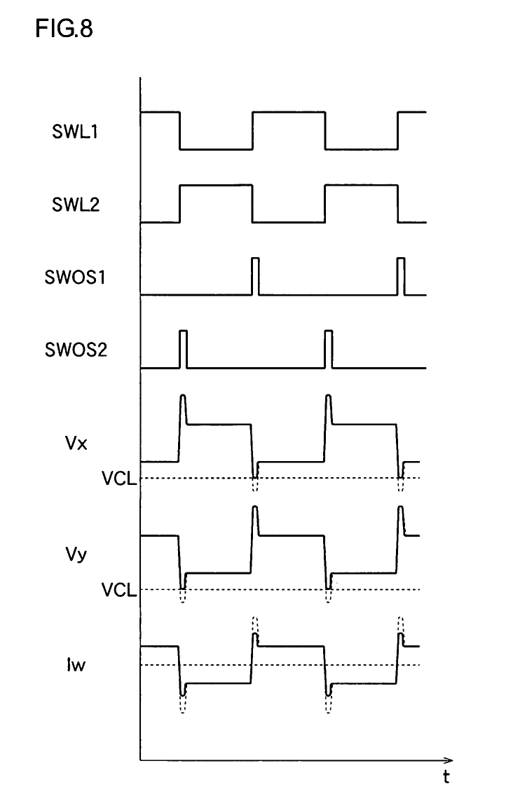

An explanation will be given concerning operation of the recording head drive circuit 16 according to the second embodiment configured as above. FIG. 8 is an operating waveform diagram of the recording head drive circuit 16 of FIG. 6. In FIG. 8, for comparison, a waveform in which clamping is not carried out, is shown by a broken line.

In a state in which the overshoot time period is short, it is possible to secure a larger overshoot amount, the smaller the write current Iw is, and as the write current Iw becomes large, it becomes difficult to secure the necessary overshoot amount. Accordingly, if circuit design is performed such that an adequate overshoot amount can be obtained when the write current Iw is large, there are cases in which the overshoot amount becomes too large when the write current Iw is small.

As shown in FIG. 6, if the first voltage Vx and the second voltage Vy are clamped, the overshoot amount of the write current Iw becomes small in comparison to cases in which clamping is not carried out, and it is possible to curtail the overshoot amount from becoming too large. In other words, by appropriately setting the clamp voltage VCL, it is possible to adjust the overshoot amount of the write current Iw to a desired value.

Furthermore, by changing the clamp voltage VCL in accordance with the write current Iw, it is possible to set the overshoot amount to an optimum value in accordance with the write current Iw. The clamp circuit 60 is not limited to a configuration of FIG. 7, and if the first voltage Vx and the second voltage Vy can be clamped, any configuration is possible.

### Third Embodiment

The second embodiment focuses on behavior when the voltage Vx and Vy of the two terminals of the recording head 12 swing in a ground (or negative supply voltage) direction, and an explanation was given concerning technology for controlling the overshoot amount. Compared with this, the third embodiment explained below focuses on behavior when the voltage Vx and Vy of the two terminals of the recording head 12 swing in a supply voltage Vdd direction, and concerns controlling the overshoot amount.

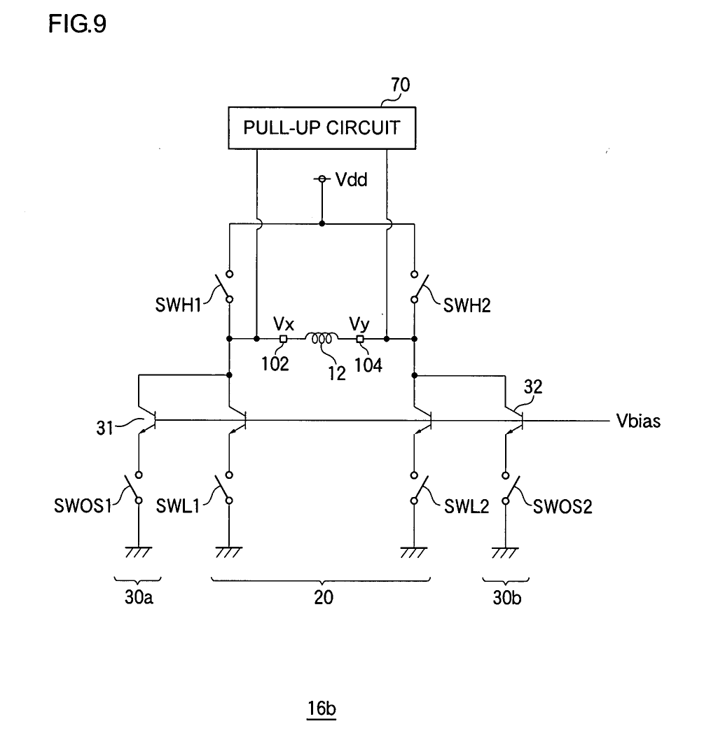

FIG. 9 is a circuit diagram showing a configuration of a recording head drive circuit 16b according to the third embodiment. A pull-up circuit 70, during an overshoot time period Tos, pulls up the voltages Vx and Vy of the two terminals of the recording head 12 independently to a predetermined pull-up level. Below, the write current Iw flowing in the recording head 12 has a first direction when flowing from the first terminal 102 to the second terminal 104, and has a second direction when flowing from the second terminal 104 to the first terminal 102. When the write current Iw switches from the first direction to the second direction, the pull-up circuit 70 pulls up the voltage Vx of the first terminal 102, and when the write current Iw switches from the second direction to the first direction, pulls up the voltage Vy of the second terminal 104.

It is desirable that the pull-up circuit 70 gradually changes the pull-up level in accordance with the overshoot amount of the write current Iw.

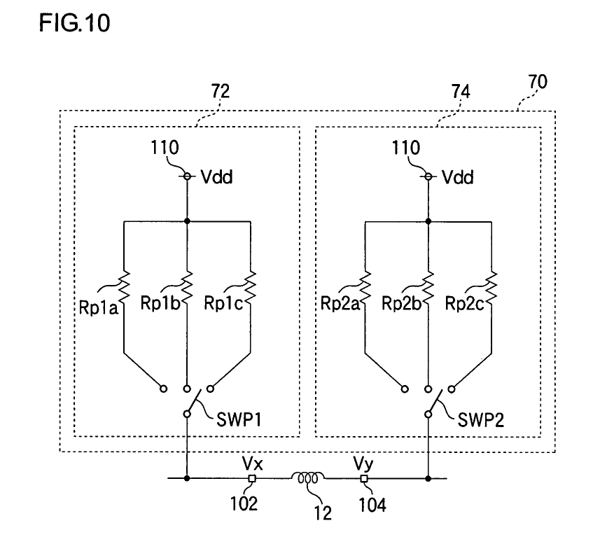

FIG. 10 is a circuit diagram showing a configuration example of the pull-up circuit 70. The pull-up circuit 70 includes a first pull-up circuit 72 and a second pull-up circuit 74. The first pull-up circuit 72 and the second pull-up circuit 74 have a similar configuration.

The first pull-up circuit 72 is arranged in series on a path from the power supply terminal 110 to the first terminal 102 of the recording head 12, and includes first resistance components Rp1a to Rp1c and a first switch SWP1. In the same way, the second pull-up circuit 74 includes second resistance components Rp2a to Rp2c and a second switch SPW2. The resistance values of the resistance components Rp1a to Rp1c and Rp2a to Rp2c are set to different values.

The pull-up circuit 70 puts either of the first switch SWP1 of the first pull-up circuit 72 or the second switch SWP2 of the second pull-up circuit 74 ON, as necessary during the overshoot time period.

In cases in which the first pull-up circuit 72 pulls up the first voltage Vx of the first terminal 102 of the recording head 12, the first terminal 102 is connected to any of the resistors Rp1a to Rp1c via the first switch SWP1, and is pulled up to the supply voltage Vdd. Since the resistance values of the resistors Rp1a to Rp1c are different, the first voltage Vx is pulled up to different pull-up levels.

It is desirable that the voltage drop across the first switch SWP1 and the first resistance component Rp1a be set at a value at which, among the plurality of transistors that form the switching circuit 20, the transistor SWH1, that is arranged on a path supplying current to the first terminal 102 of the recording head 12, is not completely OFF. Since the second pull-up circuit 74 is similar to the first pull-up circuit 72, an explanation is omitted.

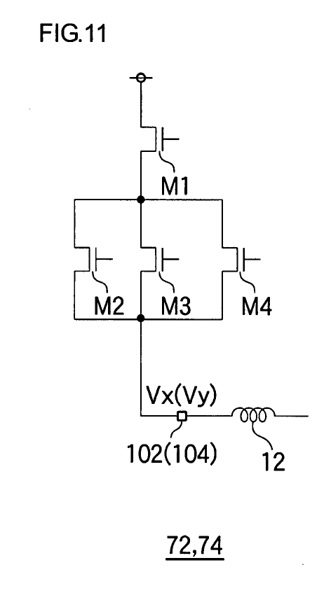

FIG. 11 is a circuit diagram showing another configuration example of the first pull-up circuit 72 (or the second pull-up circuit 74). The first pull-up circuit 72 of FIG. 11 includes a control transistor M1 that is a MOSFET, and a plurality of adjusting transistors M2 to M4.

The control transistor M1 corresponds to the first switch SWP1 of FIG. 10, and, only during the overshoot time period, functions as an ON switch as necessary. The plurality of adjusting transistors M2 to M4 are connected in series to the control transistor M1, and are connected in parallel to each other. The plurality of adjusting transistors M2 to M4 correspond to the first resistance component Rp1a of FIG. 10, and change the pull-up level by any of them being ON.

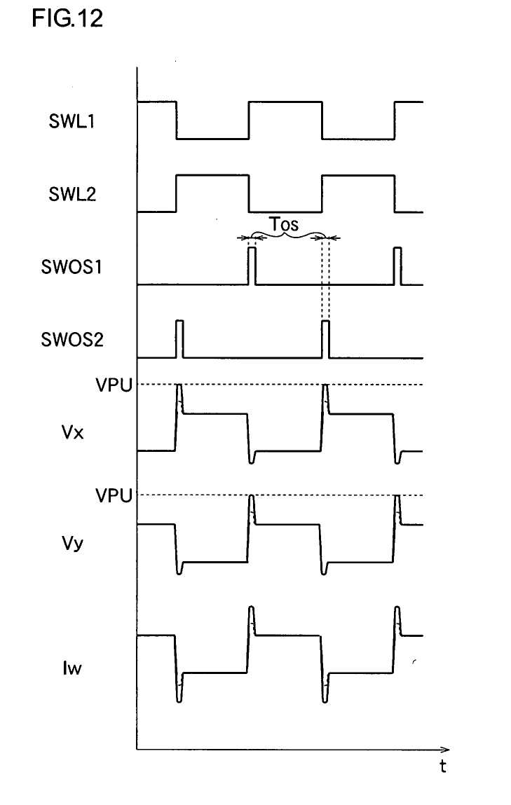

An explanation will be given concerning operation of the recording head drive circuit 16 according to the third embodiment configured as above. FIG. 12 is an operating waveform diagram of the recording head drive circuit 16b of FIG. 9. As described above, as the write current Iw becomes large, there are cases in which it becomes difficult to secure the necessary overshoot amount. Therefore, in regard to the recording head drive circuit 16b according to the present embodiment, the pull-up circuit 70 pulls up, during the overshoot time period Tos, each of the voltages Vx and Vy of the first terminal 102 and the second terminal 104 to the predetermined pull-up level VPU. By the voltages Vx and Vy of the two terminals of the recording head 12 being pulled up, it becomes possible to add a desired overshoot to the write current Iw. In addition, by gradually changing the pull-up level VPU, the overshoot amount can be changed to a desired value.

### Fourth Embodiment

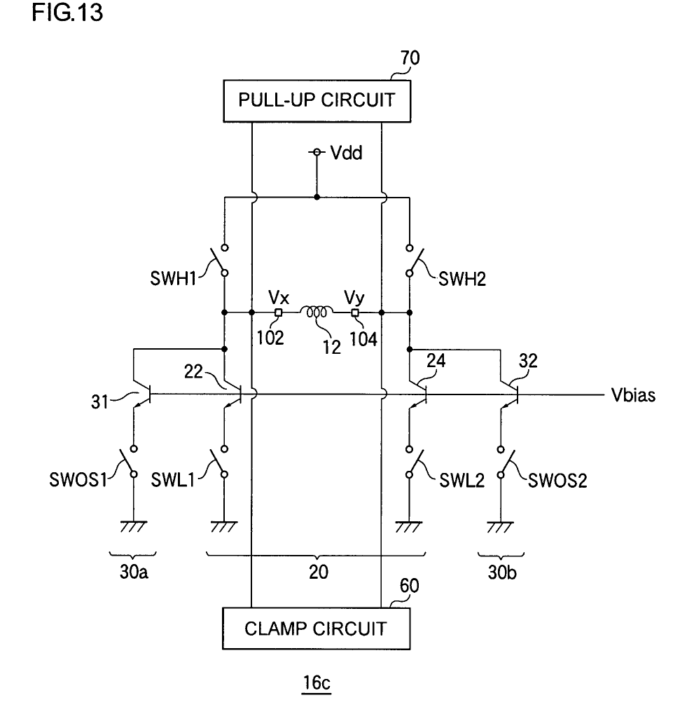

The fourth embodiment is a combination of the second and third embodiments. FIG. 13 is a circuit diagram showing a configuration of a recording head drive circuit 16c according to the fourth embodiment. According to the recording head drive circuit 16c according to the fourth embodiment, since the two effects that can be obtained in the second and the third embodiments can be obtained, in cases in which the overshoot amount is too large, it is possible to curtail the overshoot amount by the clamp circuit 60, and if the overshoot amount is insufficient, it is possible to increase the overshoot amount by the pull-up circuit 70, so that in any case, it is possible to set a desired overshoot current.

The abovementioned embodiments are examples, and a person skilled in the art will understand that various modified examples of combinations of various component elements and various processes thereof are possible, and that such modified examples are within the scope of the present invention.

In the embodiments, explanations have been given concerning the magnetic recording and reproducing apparatus 100 using the magnetic disk, but the technology according to the present invention is not limited thereto, and a flexible disk storage apparatus, a helical scanning type of video recording apparatus (VTR), a magnetic card, or the like, can similarly be applied as other magnetic recording media.

While the preferred embodiments of the present invention have been described using specific terms, such description is for illustrative purposes only, and it is to be understood that changes and variations may be made without departing from the spirit or scope of the appended claims.

What is claimed is:

1. A magnetic head drive circuit which drives a magnetic head that records information on a magnetic recording medium, the magnetic head drive circuit comprising:
a switching circuit which includes a plurality of transistors and which switches direction of a write current flowing in the magnetic head according to a conduction state of each transistor;
a write current controller which controls current value of the write current flowing in the magnetic head; and
an overshoot control circuit which adds an overshoot current to the write current flowing in the magnetic head, according to the write current, during a predetermined overshoot time period.

2. A magnetic head drive circuit according to claim 1, wherein the overshoot control circuit adds an overshoot current proportional to the write current.

3. A magnetic head drive circuit according to claim 2, wherein the switching circuit comprises:
a first high-side switching transistor arranged on a path supplying current to a first terminal of the magnetic head;
a first write current control transistor and a first low-side switching transistor arranged in series on a path which draws out current from the first terminal of the magnetic head;
a second high-side switching transistor arranged on a path supplying current to a second terminal of the magnetic head; and
a second write current control transistor and a second low-side switching transistor arranged in series on a path which draws out current from the second terminal of the magnetic head; the overshoot control circuit comprises:
a first overshoot current control transistor and a first overshoot switching transistor arranged on a path parallel to the path on which the first write current control transistor and the first low-side switching transistor are arranged; and
a second overshoot current control transistor and a second overshoot switching transistor arranged on a path parallel to the path on which the second write current control transistor and the second low-side switching transistor are arranged; wherein
the switching circuit switches direction of the write current in accordance with ON-OFF states of the first and second high-side switching transistors and the first and second low-side switching transistors;
control terminals of the first and second write current control transistors and the first and second overshoot current control transistors are commonly connected, and the write current controller controls electrical potential of the control terminals that are commonly connected; and
the overshoot control circuit switches ON either of the first and second overshoot switching transistors during the predetermined overshoot time period.

4. A magnetic head drive circuit according to claim 3, wherein the switching circuit further comprises:
a first diode and a first resistor arranged on a path from the first high-side switching transistor to a first terminal of the magnetic head; and
a second diode and a second resistor arranged on a path from the second high-side switching transistor to a second terminal of the magnetic head.

5. A magnetic head drive circuit according to claim 3, wherein the first and the second high-side switching transistors, the first and the second write current control transistors, and the first and the second overshoot current control transistors are bipolar transistors, and the first and the second low-side switching transistors and the first and the second overshoot switching transistors are field-effect transistors.

6. A magnetic head drive circuit according to claim 1, further comprising a clamp circuit which clamps voltage across two terminals of the magnetic head so that the voltage does not drop below a predetermined clamp voltage.

7. A magnetic head drive circuit according to claim 6, wherein the clamp circuit changes the predetermined clamp voltage according to the write current.

8. A magnetic head drive circuit according to claim 7, wherein the clamp circuit sets the predetermined clamp voltage low, as the write current increases.

9. A magnetic head drive circuit according to claim 6, wherein the clamp circuit comprises a bipolar transistor connected to one terminal of the magnetic head that is a target for clamping by an emitter, and adjusts the clamp voltage by controlling voltage applied to a base of the bipolar transistor.

10. A magnetic head drive circuit according to claim 1, wherein the magnetic head drive circuit is integrated on one semiconductor substrate.

11. A magnetic recording and reproducing apparatus comprising the magnetic head drive circuit according to claim 1.

12. A magnetic head drive circuit which drives a magnetic head that records information on a magnetic recording medium, the magnetic head drive circuit comprising:
a switching circuit which includes a plurality of transistors and which switches direction of a write current flowing in the magnetic head according to a conduction state of each transistor;
a write current controller which controls the write current flowing in the magnetic head;
an overshoot control circuit which adds an overshoot current, according to the write current, to the write current flowing in the magnetic head, during a predetermined overshoot time period in which the direction of the write current flowing in the magnetic head changes; and
a pull-up circuit which independently pulls up, to a predetermined pull-up level, voltage across two terminals of the magnetic head, during the overshoot time period.

13. A magnetic head drive circuit according to claim 12, wherein, with the two terminals of the magnetic head as a first terminal and a second terminal, and with direction of flow of the write current flowing in the magnetic head from the first terminal to the second terminal being a first direction, and direction of flow from the second terminal to the first terminal being a second direction, the pull-up circuit pulls up voltage of the first terminal when the write current switches from the first direction to the second direction, and pulls up voltage of the second terminal when the write current switches from the second direction to the first direction.

14. A magnetic head drive circuit according to claim 12, wherein the pull-up circuit changes the predetermined pull-up level in accordance with an overshoot amount of the write current.

15. A magnetic head drive circuit according to claim 13, wherein the pull-up circuit comprises:
a first pull-up circuit which includes a first switch and a first resistance component arranged in series on a path from a power supply voltage terminal to the first terminal of the magnetic head, and which pulls up voltage of the first terminal; and
a second pull-up circuit which includes a second switch and a second resistance component arranged in series on a path from the power supply voltage terminal to the second terminal of the magnetic head;
and wherein either of the first switch and the second switch is put ON during the overshoot time period.

16. A magnetic head drive circuit according to claim 15, wherein
a voltage drop across the first resistance component and the first switch is set at a value at which, among a plurality of transistors that make up the switching circuit, a transistor arranged on a path supplying current to the first terminal of the magnetic head is not completely OFF, and
a voltage drop across the second resistance component and the second switch is set at a value at which, among a plurality of transistors that make up the switching circuit, a transistor arranged on a path supplying current to the second terminal of the magnetic head is not completely OFF.

17. A magnetic head drive circuit according to claim 15, wherein each of the first and the second pull-up circuits comprises:
a control transistor functioning as a switch; and
a plurality of adjustment transistors connected in series to the control transistor, and connected in parallel to each other; and
changes the pull-up level according to any of the plurality of adjustment transistors being ON.

18. A magnetic head drive circuit according to claim 17, wherein the control transistor and the plurality of adjustment transistors are field-effect transistors.

19. A magnetic head drive circuit according to claim 12, wherein the magnetic head drive circuit is integrated on one semiconductor substrate.

20. A magnetic recording and reproducing apparatus comprising the magnetic head drive circuit according to claim 12.
